(19) United States
(12) Patent Application Publication
(10) Pub. No.: US 2021/0065733 A1
(43) Pub. Date: Mar. 4, 2021

(54) AUDIO DATA AUGMENTATION FOR MACHINE LEARNING OBJECT CLASSIFICATION

(71) Applicant: Mentor Graphics Corporation, Wilsonville, OR (US)

(72) Inventors: Nizar Sallem, San Jose, CA (US); Ohad Barak, Mountain View, CA (US)

(21) Appl. No.: 16/555,251

(22) Filed: Aug. 29, 2019

(51) Int. Cl. G10L 21/0324; G10L 15/08; G06K 9/62; G06N 20/00

(52) U.S. Cl. CPC G10L 21/0324; G06N 20/00; G06K 9/6256; G10L 15/08

(57) ABSTRACT

This application discloses a computing system to receive audio data corresponding to sounds emitted by objects capable of being identified in an environment. The audio data includes labels identifying types of the objects emitting the sounds. The computing system alters the audio data to generate an augmented audio data set by modifying a timing of the audio data, adjusting an amplitude of the audio data, incorporating noise corresponding to different traffic environments into the audio data, or dampening noise in the audio data. The computing system can label the augmented audio data set with the labels of the audio data altered to generate the augmented audio data set. A machine-learning classification system can be trained with the augmented audio data set, which configures machine-learning classification system to classify objects from audio measurements captured with one or more audio devices configured to sense the environment.

### TECHNICAL FIELD

This application is generally related to training of machine learning systems and, more specifically, to audio data augmentation for machine learning object classification.

### BACKGROUND

Many modern vehicles include built-in advanced driver assistance systems (ADAS) to provide automated safety and/or assisted driving functionality. For example, these advanced driver assistance systems can implement adaptive cruise control, automatic parking, automated braking, blind spot monitoring, collision avoidance, driver drowsiness detection, lane departure warning, or the like. The next generation of vehicles can include autonomous driving (AD) systems to control and navigate the vehicles independent of human interaction.

These vehicles typically include multiple sensors, such as one or more cameras, Light Detection and Ranging (Lidar) sensor, Radio Detection and Ranging (Radar) system, or the like, to measure different portions of the environment around the vehicles. Each the vehicles can include on-board processing systems to use the measurements captured over time to detect objects around the vehicle, and then provide a list of detected objects and corresponding confidence levels to the advanced driver assistance systems or the autonomous driving systems for their use in implementing automated safety and/or driving functionality.

The advanced driver assistance systems or the autonomous driving systems can utilize the list of objects and, in some cases, the associated confidence levels of their detection, to implement automated safety and/or driving functionality. For example, when a radar sensor in the front of a vehicle provides the advanced driver assistance system in the vehicle a list having an object in a current path of the vehicle, the advanced driver assistance system can provide a warning to the driver of the vehicle or control the vehicle in order to avoid a collision with the object.

Some of the on-board processing systems can at least partially detect the objects from captured audio data through the use of an audio classification system. For example, the audio classification system can compare the audio data to a known set of sounds emitted by objects and classify the audio data based on the comparison. Recently, machine learning technologies have begun to be implemented into data processing systems within vehicles, for example, to classify measured data to identify objects around a vehicle. Attempts to implement an audio classification system with machine learning technologies, however, have been stifled by an absence of labeled audio datasets capable of adequately training machine learning systems. Acquisition of audio data and subsequent labeling remains a time-consuming task, as each new object, to characterize, typically has multiple different recordings of emitted sounds in a labeled audio dataset, for example, to account for object location, object movement, and the associated environment.

### SUMMARY

This application discloses a computing system to receive audio data corresponding to sounds emitted by objects capable of being located or identified in an environment. The audio data includes labels identifying types of the objects emitting the sounds. The computing system alters the audio data to generate an augmented audio data set by modifying a timing of the audio data, adjusting an amplitude of the audio data, incorporating noise corresponding to different traffic environments into the audio data, or dampening noise in the audio data. The computing system can label the augmented audio data set with the labels of the audio data altered to generate the augmented audio data set.

The augmented audio data set can utilized to train a machine learning object classification system, for example, in driver assistance systems and/or automated driving systems of a vehicle. The machine-learning classification system, once trained with the augmented audio data set, can be configured to classify objects from audio measurements captured with one or more audio devices configured to sense the environment. The vehicle implementing the driver assistance systems and/or the automated driving systems can include a control system configured to control operation of the vehicle based, at least in part, on the type of object corresponding to the classified audio measurements. Embodiments will be described below in greater detail.

### DESCRIPTION OF THE DRAWINGS

FIG. 1 illustrates an example autonomous driving system with audio perception according to various embodiments.

FIG. 2A illustrates an example measurement coordinate fields for a sensor system deployed in a vehicle according to various embodiments.

FIG. 2B illustrates an example environmental coordinate field associated with an environmental model for a vehicle according to various embodiments.

FIG. 3 illustrates an example sensor fusion system with captured audio according to various examples.

FIG. 4 illustrates an example audio data expansion system to generate an augmented audio data set for training a machine-learning object classifier in an audio processing system according to various examples.

FIG. 5 illustrates an example flowchart for augmenting audio data for training a machine-learning object classifier in an audio processing system according to various examples.

FIGS. 6 and 7 illustrate an example of a computer system of the type that may be used to implement various embodiments.

### DETAILED DESCRIPTION

Autonomous Driving with Audio Data-Based Object Classification

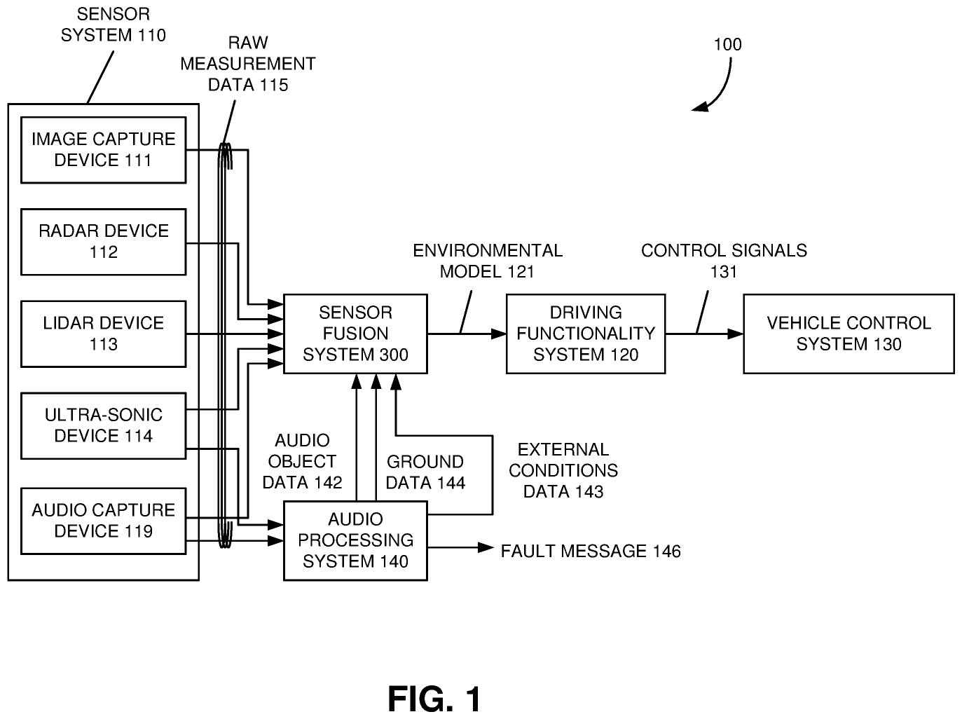

FIG. 1 illustrates an example autonomous driving system 100 according to various embodiments. Referring to FIG. 1, the autonomous driving system 100, when installed in a vehicle, can sense an environment surrounding the vehicle and control operation of the vehicle based, at least in part, on the sensed environment or interpreted environment.

The autonomous driving system 100 can include a sensor system 110 having multiple sensors, each of which can measure different portions and/or aspects of the environment surrounding the vehicle and output the measurements as raw measurement data 115. The raw measurement data 115 can include characteristics of light, electromagnetic waves, or sound captured by the sensors, such as an intensity or a frequency of the light, electromagnetic waves, or the sound, an angle of reception by the sensors, a time delay between a transmission and the corresponding reception of the light, electromagnetic waves, or the sound, a time of capture of the light, electromagnetic waves, or sound, or the like.

The sensor system 110 can include multiple different types of sensors, such as, but not restricted to, an image capture device 111, a Radio Detection and Ranging (Radar) device 112, a Light Detection and Ranging (Lidar) device 113, an ultra-sonic device 114, audio capture device 119, infrared or night-vision cameras, time-of-flight cameras, cameras capable of detecting and transmitting differences in pixel intensity, or the like. The image capture device 111, such as one or more cameras, can capture at least one image of at least a portion of the environment surrounding the vehicle. The image capture device 111 can output the captured image(s) as raw measurement data 115, which, in some embodiments, can be unprocessed and/or uncompressed pixel data corresponding to the captured image(s).

The radar device 112 can emit radio signals into the environment surrounding the vehicle. Since the emitted radio signals may reflect off of objects in the environment, the radar device 112 can detect the reflected radio signals incoming from the environment. The radar device 112 can measure the incoming radio signals by, for example, measuring a signal strength of the radio signals, a reception angle, a frequency, or the like. The radar device 112 can also measure a time delay between an emission of a radio signal and a measurement of the incoming radio signals from the environment that corresponds to emitted radio signals reflected off of objects in the environment. The radar device 112 can output the measurements of the incoming radio signals as the raw measurement data 115.

The lidar device 113 can transmit light, such as from a laser or other optical transmission device, into the environment surrounding the vehicle. The transmitted light, in some embodiments, can be pulses of visible light, near infrared light, or the like. Since the transmitted light can reflect off of objects in the environment, the lidar device 113 can include a photo detector to measure light incoming from the environment. The lidar device 113 can measure the incoming light by, for example, measuring an intensity of the light, a wavelength, or the like. The lidar device 113 can also measure a time delay between a transmission of a light pulse and a measurement of the light incoming from the environment that corresponds to the transmitted light having reflected off of objects in the environment. The lidar device 113 can output the measurements of the incoming light and the time delay as the raw measurement data 115.

The ultra-sonic device 114 can emit ultra-sonic pulses, for example, generated by transducers or the like, into the environment surrounding the vehicle. The ultra-sonic device 114 can detect ultra-sonic pulses incoming from the environment, such as, for example, the emitted ultra-sonic pulses having been reflected off of objects in the environment. The ultra-sonic device 114 can also measure a time delay between emission of the ultra-sonic pulses and reception of the ultra-sonic pulses from the environment that corresponds to the emitted ultra-sonic pulses having reflected off of objects in the environment. The ultra-sonic device 114 can output the measurements of the incoming ultra-sonic pulses and the time delay as the raw measurement data 115.

The audio capture device 119 can include a microphone, an array of microphones, an infrasound capture device, an ultrasound capture device, or the like, mounted to the vehicle, which can detect sound incoming from the environment, such as sounds generated from objects external to the vehicle, ambient naturally present sounds, sounds generated by the vehicle having been reflected off of objects in the environment, sounds generated by an interaction of the vehicle with the environment or other objects interacting with the environment, or the like. In some embodiments, the audio or sound captured by the audio capture device 119 can correspond to acoustic wave energy within the human hearing range, such as between the frequencies of 20 Hz-20,000 Hz, and/or acoustic wave energy falling outside of the human hearing range. The audio capture device 119 can output the sounds measurements or captured audio as the raw measurement data 115.

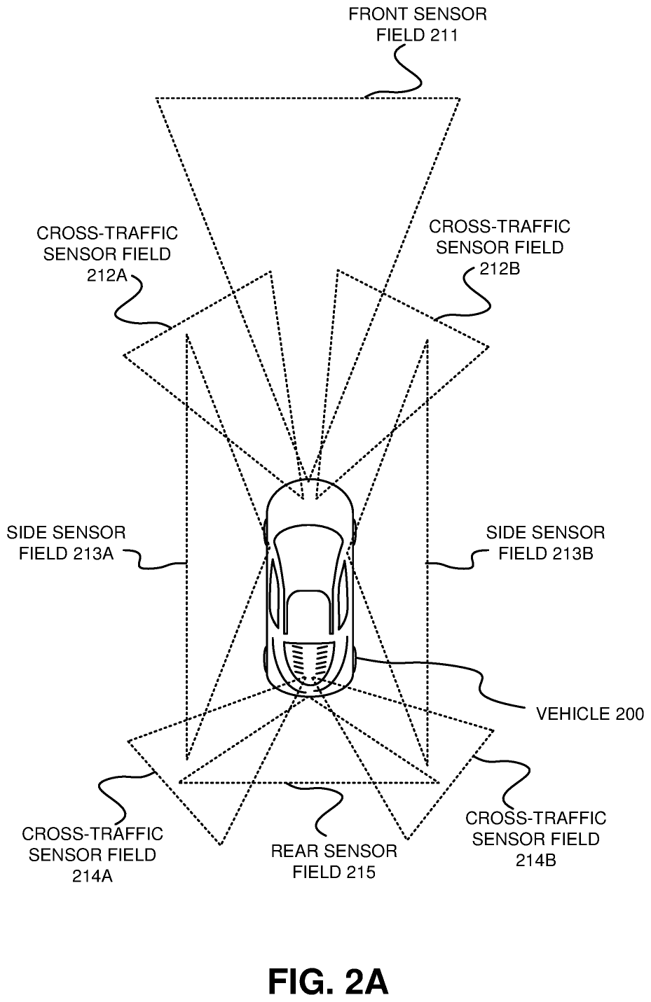

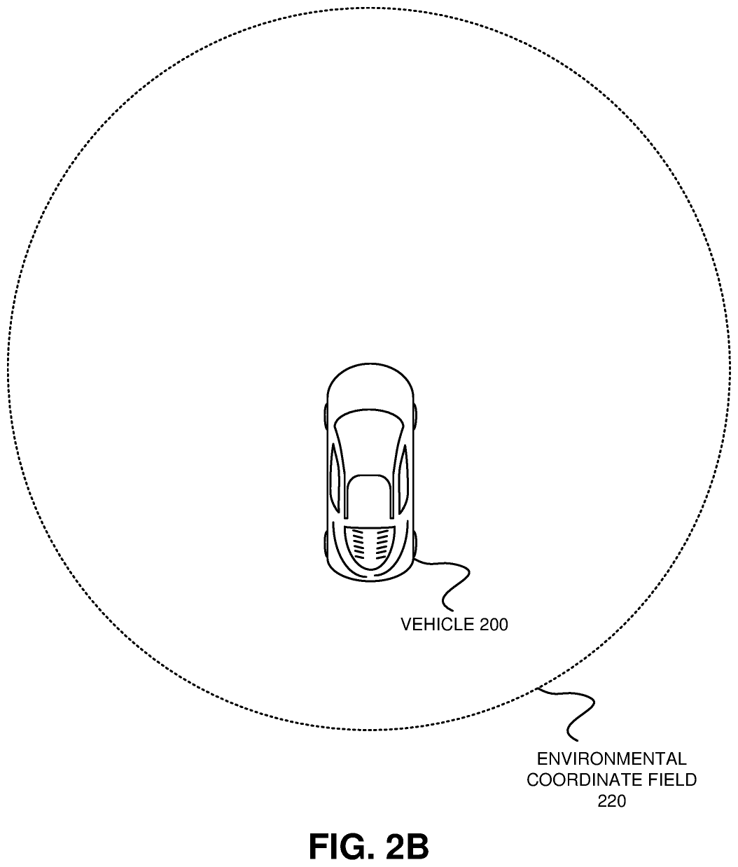

The different sensors in the sensor system 110 can be mounted to the vehicle to capture measurements for different portions of the environment surrounding the vehicle. FIG. 2A illustrates an example measurement coordinate fields for a sensor system deployed in a vehicle 200 according to various embodiments. Referring to FIG. 2A, the vehicle 200 can include multiple different sensors capable of detecting incoming signals, such as light signals, electromagnetic signals, and sound signals. Each of these different sensors can have a different field of view into an environment around the vehicle 200. These fields of view can allow the sensors to measure light and/or sound in different measurement coordinate fields.

The vehicle in this example includes several different measurement coordinate fields, including a front sensor field 211, multiple cross-traffic sensor fields 212A, 212B, 214A, and 214B, a pair of side sensor fields 213A and 213B, and a rear sensor field 215. Each of the measurement coordinate fields can be sensor-centric, meaning that the measurement coordinate fields can describe a coordinate region relative to a location of its corresponding sensor. In the case of audio capture devices, such as microphones, an infrasound capture device, an ultrasound capture device, or the like, sound can be captured in with three-dimensional directionality, for example, from above, or below the audio caption design as well as from the sides of the vehicle or from inside the vehicle.

Referring back to FIG. 1, the autonomous driving system 100 can include a sensor fusion system 300 to receive the raw measurement data 115 from the sensor system 110 and populate an environmental model 121 associated with the vehicle with the raw measurement data 115. In some embodiments, the environmental model 121 can have an environmental coordinate field corresponding to a physical envelope surrounding the vehicle, and the sensor fusion system 300 can populate the environmental model 121 with the raw measurement data 115 based on the environmental coordinate field. In some embodiments, the environmental coordinate field can be a non-vehicle centric coordinate field, for example, a world coordinate system, a path-centric coordinate field, or the like.

FIG. 2B illustrates an example environmental coordinate field 220 associated with an environmental model for the vehicle 200 according to various embodiments. Referring to FIG. 2B, an environment surrounding the vehicle 200 can correspond to the environmental coordinate field 220 for the environmental model. The environmental coordinate field 220 can be vehicle-centric and provide a 360 degree area around the vehicle 200, which can include a volume above and below portions of the 360 degree area, for example, a spherical geometry around the vehicle 200. The environmental model can be populated and annotated with information detected by the sensor fusion system 300 or inputted from external sources. Embodiments will be described below in greater detail.

Referring back to FIG. 1, to populate the raw measurement data 115 into the environmental model 121 associated with the vehicle, the sensor fusion system 300 can spatially align the raw measurement data 115 to the environmental coordinate field of the environmental model 121. The sensor fusion system 300 can also identify when the sensors captured the raw measurement data 115, for example, by time stamping the raw measurement data 115 when received from the sensor system 110. The sensor fusion system 300 can populate the environmental model 121 with the time stamp or other time-of-capture information, which can be utilized to temporally align the raw measurement data 115 in the environmental model 121.

The autonomous driving system 100 can include an audio processing system 140 to receive raw measurement data 115 corresponding to captured audio or sound, for example, from the audio capture device 119 and/or the ultra-sonic device 114 in the sensor system 110. The audio processing system 140 can generate audio object data 142 from the raw measurement data 115 corresponding to the captured audio and/or audio features derived from the captured audio. The audio object data 142 can describe a type of object that corresponds to the captured audio, a directionality of the captured audio relative to the vehicle, or the like. The audio object data 142 also can include or be accompanied by a confidence level for the association of captured audio to the type of object described in the audio object data 142 by the audio processing system 140.

The audio processing system 140 can filter the captured audio to remove sounds or noise originating from the vehicle, sounds coming from particular directions, and/or corresponding to environmental conditions, such as road condition or weather. In some embodiments, the audio processing system 140 can utilize a machine-learning classifier or machine-learning network, such as a convolutional neural network (CNN), Support Vector Machine (SVM), or the like, trained with labeled audio to determine object labels for capture audio input to the machine-learning network. Embodiments of training an audio processing system utilizing a machine-learning classifier with labeled audio data will be described below in greater detail. The audio object data 142 can include the object labels output from the machine-learning network, which correlate the captured audio to the type of objects in the environment around the vehicle.

The audio processing system 140 can generate external conditions data 143 from the raw measurement data 115 corresponding to the captured audio. In some examples, the audio processing system 140 can detect weather conditions, such as rain, snow, ice, wind, or the like, based on the captured audio. The audio processing system 140 can also detect a condition of a roadway, such as gravel road, standing water, vibration caused by safety features added to the roadway, or the like, based on the captured audio. The audio processing system 140 may detect a type of infrastructure associated with a roadway, such as railroad crossing, tunnels, bridges, overpasses, or the like, based on the captured audio. The audio processing system 140 may detect traffic relevant information, such as emergency breaking of another vehicle, vehicle sliding on black ice, or the like. The external conditions data 143 can include the weather conditions information, roadway conditions information, infrastructure information, or the like.

In some embodiments, the audio processing system 140 can identify sounds in the captured audio that originated from the vehicle and utilize identified sounds to generate ground data 144, a fault message 146, or the like. The ground data 144 can correspond to a reference to a location of the ground relative to the vehicle, for example, by determining a reflection of the sound emitted by the vehicle or its sensors and then utilizing the reflection to determine the reference to the ground. The fault message 146 can correspond to an alert for the autonomous driving system 100 that the vehicle includes a mechanical fault, such as a flat tire, broken piston, engine friction, squeaky brakes, or the like.

The sensor fusion system 300 can populate the audio object data 142 into the environmental model 121. The sensor fusion system 300 can analyze the raw measurement data 115 from the multiple sensors as populated in the environmental model 121 and the audio object data 142 to detect a sensor event or at least one object in the environmental coordinate field associated with the vehicle. The sensor event can include a sensor measurement event corresponding to a presence of the raw measurement data 115 and/or audio object data 142 in the environmental model 121, for example, above a noise threshold. The sensor event can include a sensor detection event corresponding to a spatial and/or temporal grouping of the raw measurement data 115 and/or audio object data 142 in the environmental model 121. The object can correspond to spatial grouping of the raw measurement data 115 having been tracked in the environmental model 121 over a period of time, allowing the sensor fusion system 300 to determine the raw measurement data 115 corresponds to an object around the vehicle. The sensor fusion system 300 can populate the environment model 121 with an indication of the detected sensor event or detected object and a confidence level of the detection. Embodiments of sensor fusion and sensor event detection or object detection will be described below in greater detail.

The autonomous driving system 100 can include a driving functionality system 120 to receive at least a portion of the environmental model 121 from the sensor fusion system 300. The driving functionality system 120 can analyze the data included in the environmental model 121 to implement automated driving functionality or automated safety and assisted driving functionality for the vehicle. The driving functionality system 120 can generate control signals 131 based on the analysis of the environmental model 121.

The autonomous driving system 100 can include a vehicle control system 130 to receive the control signals 131 from the driving functionality system 120. The vehicle control system 130 can include mechanisms to control operation of the vehicle, for example by controlling different functions of the vehicle, such as braking, acceleration, steering, parking brake, transmission, user interfaces, warning systems, or the like, in response to the control signals.

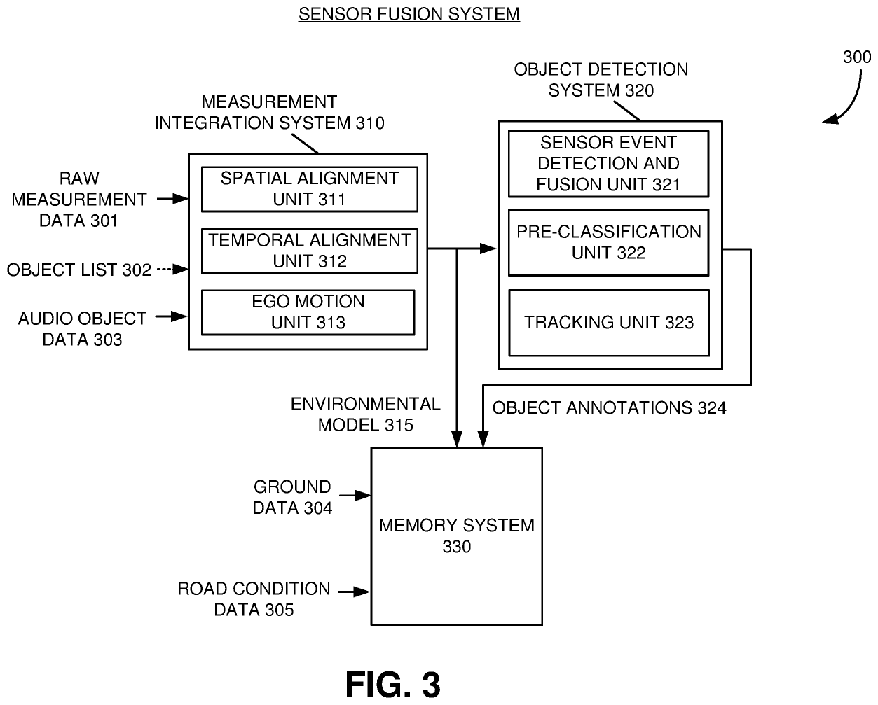

FIG. 3 illustrates an example sensor fusion system 300 according to various examples. Referring to FIG. 3, the sensor fusion system 300 can include a measurement integration system 310 to receive raw measurement data 301 from multiple sensors mounted to a vehicle and audio object data 303 from an audio processing system in the vehicle. The measurement integration system 310 can generate an environmental model 315 for the vehicle, which can be populated with the raw measurement data 301 and/or audio object data 303.

The measurement integration system 310 can include a spatial alignment unit 311 to correlate measurement coordinate fields of the sensors to an environmental coordinate field for the environmental model 315. The measurement integration system 310 can utilize this correlation to convert or translate locations for the raw measurement data 301 within the measurement coordinate fields into locations within the environmental coordinate field. The measurement integration system 310 can populate the environmental model 315 with the raw measurement data 301 based on the correlation between the measurement coordinate fields of the sensors to the environmental coordinate field for the environmental model 315.

The measurement integration system 310 can also temporally align the raw measurement data 301 from different sensors in the sensor system. In some embodiments, the measurement integration system 310 can include a temporal alignment unit 312 to assign time stamps to the raw measurement data 301 and/or audio object data 303 based on when the sensor captured the raw measurement data 301 and/or capture audio corresponding to the audio object data 303, when the raw measurement data 301 and/or audio object data 303 was received by the measurement integration system 310, or the like. In some embodiments, the temporal alignment unit 312 can convert a capture time of the raw measurement data 301 provided by the sensors into a time corresponding to the sensor fusion system 300. The measurement integration system 310 can annotate the raw measurement data 301 populated in the environmental model 315 with the time stamps for the raw measurement data 301. The time stamps for the raw measurement data 301 can be utilized by the sensor fusion system 300 to group the raw measurement data 301 in the environmental model 315 into different time periods or time slices. In some embodiments, a size or duration of the time periods or time slices can be based, at least in part, on a refresh rate of one or more sensors in the sensor system. For example, the sensor fusion system 300 can set a time slice to correspond to the sensor with a fastest rate of providing new raw measurement data 301 to the sensor fusion system 300.

The measurement integration system 310 can include an ego motion unit 313 to compensate for movement of at least one sensor capturing the raw measurement data 301, for example, due to the vehicle driving or moving in the environment. The ego motion unit 313 can estimate motion of the sensor capturing the raw measurement data 301, for example, by utilizing tracking functionality to analyze vehicle motion information, such as global positioning system (GPS) data, inertial measurements, vehicle odometer data, video images, or the like. The tracking functionality can implement a Kalman filter, a Particle filter, optical flow-based estimator, or the like, to track motion of the vehicle and its corresponding sensors relative to the environment surrounding the vehicle.

The ego motion unit 313 can utilize the estimated motion of the sensor to modify the correlation between the measurement coordinate field of the sensor to the environmental coordinate field for the environmental model 315. This compensation of the correlation can allow the measurement integration system 310 to populate the environmental model 315 with the raw measurement data 301 at locations of the environmental coordinate field where the raw measurement data 301 was captured as opposed to the current location of the sensor at the end of its measurement capture.

In some embodiments, the measurement integration system 310 may receive objects or object lists 302 from a variety of sources. The measurement integration system 310 can receive the object list 302 from sources external to the vehicle, such as in a vehicle-to-vehicle (V2V) communication, a vehicle-to-infrastructure (V2I) communication, a vehicle-to-pedestrian (V2P) communication, a vehicle-to-device (V2D) communication, a vehicle-to-grid (V2G) communication, or generally a vehicle-to-everything (V2X) communication. The measurement integration system 310 can also receive the objects or an object list 302 from other systems internal to the vehicle, such as from a human machine interface, mapping systems, localization system, driving functionality system, vehicle control system, or the vehicle may be equipped with at least one sensor that outputs the object list 302 rather than the raw measurement data 301.

The measurement integration system 310 can receive the object list 302 and populate one or more objects from the object list 302 into the environmental model 315 along with the raw measurement data 301. The object list 302 may include one or more objects, a time stamp for each object, and optionally include a spatial metadata associated with a location of objects in the object list 302. For example, the object list 302 can include speed measurements for the vehicle, which may not include a spatial component to be stored in the object list 302 as the spatial metadata. When the object list 302 includes a confidence level associated with an object in the object list 302, the measurement integration system 310 can also annotate the environmental model 315 with the confidence level for the object from the object list 302.

The sensor fusion system 300 can include an object detection system 320 to receive the environmental model 315 from the measurement integration system 310. In some embodiments, the sensor fusion system 300 can include a memory system 330 to store the environmental model 315 from the measurement integration system 310. The object detection system 320 may access the environmental model 315 from the memory system 330 as well as ground data 304 and road condition data 305.

The object detection system 320 can analyze data stored in the environmental model 315 to detect a sensor detection event or at least one object. The sensor fusion system 300 can populate the environment model 315 with an indication of the sensor detection event or detected object at a location in the environmental coordinate field corresponding to the detection. The sensor fusion system 300 can also identify a confidence level associated with the detection, which can be based on at least one of a quantity, a quality, or a sensor diversity of raw measurement data 301 and/or audio object data 303 utilized in detecting the sensor detection event or detected object. In some embodiments, the sensor fusion system 300 can utilize the audio object data 303 confirm a detection of a sensor detection event or object, and thus increase a confidence level of the detection. The sensor fusion system 300 can populate the environment model 315 with the confidence level associated with the detection. For example, the object detection system 320 can annotate the environmental model 315 with object annotations 324, which populates the environmental model 315 with the detected sensor detection event or detected object and corresponding confidence level of the detection.

The object detection system 320 can include a sensor event detection and fusion unit 321 to monitor the environmental model 315 to detect sensor measurement events. The sensor measurement events can identify locations in the environmental model 315 having been populated with the raw measurement data 301 and/or audio object data 303 for a sensor, for example, above a threshold corresponding to noise in the environment. In some embodiments, the sensor event detection and fusion unit 321 can detect the sensor measurement events by identifying changes in intensity within the raw measurement data 301 and/or audio object data 303 over time, changes in reflections within the raw measurement data 301 and/or audio object data 303 over time, change in pixel values, or the like.

The sensor event detection and fusion unit 321 can analyze the raw measurement data 301 and/or audio object data 303 in the environmental model 315 at the locations associated with the sensor measurement events to detect one or more sensor detection events. In some embodiments, the sensor event detection and fusion unit 321 can identify a sensor detection event when the raw measurement data 301 and/or the audio object data 303 associated with a single sensor meets or exceeds sensor event detection threshold. For example, when the audio object data 303 corresponds to a location not visible to the other sensors in the vehicle, the sensor event detection and fusion unit 321 can utilize to the audio object data 303 to identify a sensor detection event.

The sensor event detection and fusion unit 321, in some embodiments, can combine the identified sensor detection event for a single sensor with raw measurement data 301 and/or the audio object data 303 associated with one or more sensor measurement events or sensor detection events captured by at least another sensor to generate a fused sensor detection event. The fused sensor detection event can correspond to raw measurement data 301 from multiple sensors and/or the audio object data 303 from the audio processing system, at least one of which corresponds to the sensor detection event identified by the sensor event detection and fusion unit 321.

The object detection system 320 can include a pre-classification unit 322 to assign a pre-classification to the sensor detection event or the fused sensor detection event. In some embodiments, the pre-classification can correspond to a type of object, such as another vehicle, a pedestrian, a cyclist, an animal, a static object, or the like. When the sensor detection event or the fused sensor detection event was based on the audio object data 303, the pre-classification unit 322 can set the pre-classification to correspond to the label in the audio object data 303. For example, when the pre-classification unit 322 determines the type of object corresponds to an emergency vehicle, the pre-classification unit 322 can utilize any audio object data 303 corresponding to a siren originating near the emergency vehicle to confirm the pre-classification. In some embodiments, the pre-classification unit 322 can utilize the audio object data 303 to identify a state of an object. Using the emergency vehicle example, the pre-classification unit 322 can utilize the presence or absence of the siren in the audio object data 303 to classify the state of the emergency vehicle as either operating in an emergency response state or a normal vehicle state. The pre-classification unit 322 can annotate the environmental model 315 with the sensor detection event, the fused sensor detection event and/or the assigned pre-classification.

The object detection system 320 can also include a tracking unit 323 to track the sensor detection events or the fused sensor detection events in the environmental model 315 over time, for example, by analyzing the annotations in the environmental model 315, and determine whether the sensor detection event or the fused sensor detection event corresponds to an object in the environmental coordinate system. In some embodiments, the tracking unit 323 can track the sensor detection event or the fused sensor detection event utilizing at least one state change prediction model, such as a kinetic model, a probabilistic model, or other state change prediction model.

The tracking unit 323 can select the state change prediction model to utilize to track the sensor detection event or the fused sensor detection event based on the assigned pre-classification of the sensor detection event or the fused sensor detection event by the pre-classification unit 322. The state change prediction model may allow the tracking unit 323 to implement a state transition prediction, which can assume or predict future states of the sensor detection event or the fused sensor detection event, for example, based on a location of the sensor detection event or the fused sensor detection event in the environmental model 315, a prior movement of the sensor detection event or the fused sensor detection event, a classification of the sensor detection event or the fused sensor detection event, or the like. In some embodiments, for example, the tracking unit 323 implementing the kinetic model can utilize kinetic equations for velocity, acceleration, momentum, or the like, to assume or predict the future states of the sensor detection event or the fused sensor detection event based, at least in part, on its prior states. The tracking unit 323 may determine a difference between the predicted future state of the sensor detection event or the fused sensor detection event and its actual future state, which the tracking unit 323 may utilize to determine whether the sensor detection event or the fused sensor detection event is an object. After the sensor detection event or the fused sensor detection event has been identified by the pre-classification unit 322, the tracking unit 323 can track the sensor detection event or the fused sensor detection event in the environmental coordinate field associated with the environmental model 315, for example, across multiple different sensors and their corresponding measurement coordinate fields.

When the tracking unit 323, based on the tracking of the sensor detection event or the fused sensor detection event with the state change prediction model, determines the sensor detection event or the fused sensor detection event is an object, the object tracking unit 323 can annotate the environmental model 315 to indicate the presence of the object. The tracking unit 323 can continue tracking the detected object over time by implementing the state change prediction model for the object and analyzing the environmental model 315 when updated with additional raw measurement data 301. After the object has been detected, the tracking unit 323 can track the object in the environmental coordinate field associated with the environmental model 315, for example, across multiple different sensors and their corresponding measurement coordinate fields. Although FIG. 3 shows the audio object data generated by an audio processing system as being integrated with measurements from other sources to detect objects in an environment, in some embodiments, the audio processing system and a localization system can be in a stand-alone implementation, for example, classifying audio data for use in vehicle localization by the localization system.

### Audio Data Augmentation for Machine-Learning Object Classifier Training

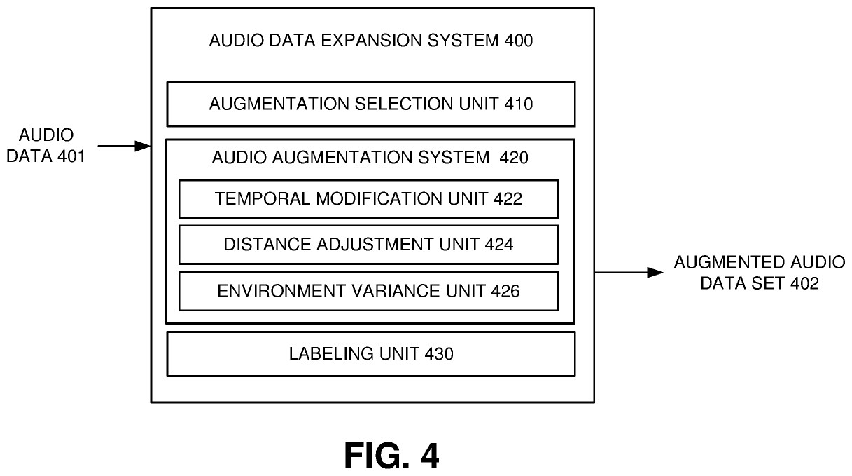

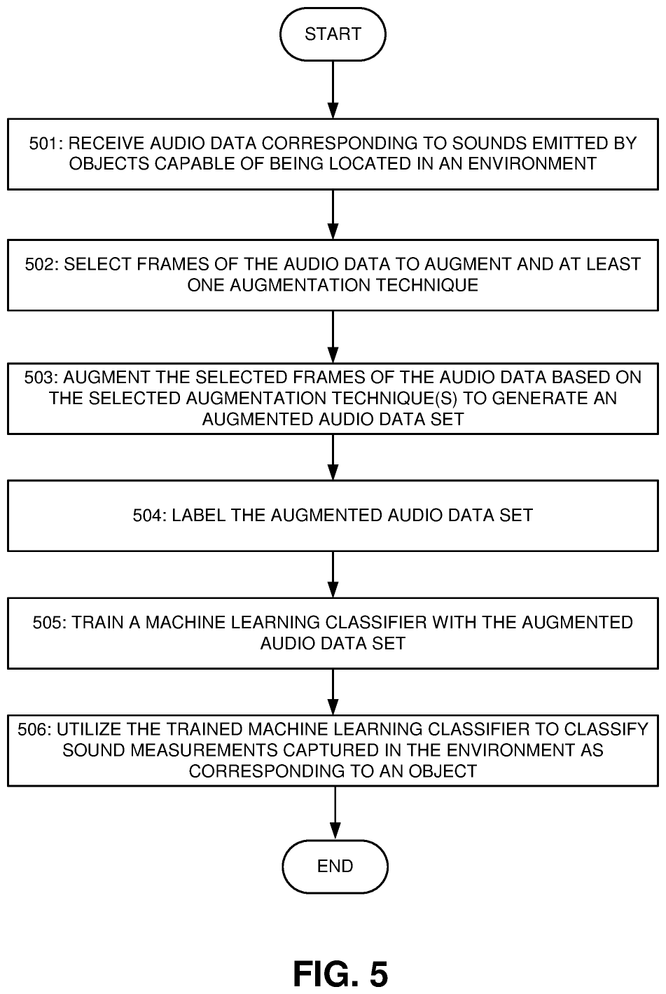

FIG. 4 illustrates an example audio data expansion system 400 to generate an augmented audio data set 402 for training a machine-learning object classifier in an audio processing system according to various examples. FIG. 5 illustrates an example flowchart for augmenting audio data for training a machine-learning object classifier in an audio processing system according to various examples. Referring to FIGS. 4 and 5, the audio data expansion system 400, in a block 501, can receive audio data 401 corresponding to sounds emitted by objects capable of being located in an environment. For example, when the environment corresponds to locations around a vehicle, the audio data 401 can correspond to sounds generated from objects capable of being located external to the vehicle, ambient naturally present sounds, sounds capable of being generated by the vehicle having been directly recorded and/or reflected off of objects in the environment, or the like. The audio data 401 can correspond to acoustic wave energy within the human hearing range, such as between the frequencies of 20 Hz-20,000 Hz, and/or acoustic wave energy falling outside of the human hearing range. In some embodiments, the audio data 401 can have a format capable of being utilized to train the machine-learning object classifier, for example, divided into audio frames labeled based on a type of objects having emitted or produced the sounds. While the audio data 401 may be formatted to train the machine-learning classifier, the audio data 401 may be sufficiently small or non-diverse that, if used to train the machine-learning object classifier alone, may cause the machine-learning object classifier to classify or identify sound measurements as corresponding to objects with a large generalization error and poor robustness.

In some embodiments, the audio data expansion system 400 can receive the audio data 401 in a format not capable of being utilized to train the machine-learning object classifier. The audio data expansion system 400 can pre-process the audio data 401 to convert the audio data 401 into a format capable of being utilized to train the machine-learning object classifier, for example, by dividing the audio data 401 into audio frames and labeling the frames of the audio data 401 with types of objects associated with the sounds of the frames of the audio data 401.

The audio data expansion system 400 can expand the audio data 401 into a larger and/or more diverse audio data set, which can allow the machine-learning classifier to be trained to classify sound measurements as corresponding to object types, for example, with a lower generalization error and increased robustness. The audio data expansion system 400 can expand the audio data 401 into a larger and/or more diverse audio data set by selectively augmenting frames of the audio data 401 to generate new versions of the audio data 401 that simulate the sounds being emitted from the objects in different locations, in different environments, with different operational states, or the like.

The audio data expansion system 400 can include an augmentation selection unit 410 that, in a block 502, can select frames of the audio data 401 to augment and select at least one augmentation technique to utilize to augment the frames of the audio data 401. In some embodiments, the augmentation selection unit 410 can select all of the frames of the audio data 401 to augment with at least one augmentation technique or select at least a subset of the frames of the audio data 401 to augment randomly, semi-randomly, or the like.

The augmentation selection unit 410 also can select which of a plurality of augmentation techniques to utilize to alter the selected frames of the audio data 401. In some embodiments, the audio data expansion system 400 can implement a temporal modification augmentation technique, a distance adjustment augmentation technique, a frequency adjustment modification technique, an environmental augmentation technique, or the like, and the augmentation selection unit 410 can select one or more of the augmentation techniques to utilize to augment the selected frames of the audio data 401. The augmentation selection unit 410 also may be capable of selecting how each of the selected augmentation techniques performs the augmentation.

The audio data expansion system 400 can include an audio augmentation system 420 that, in a block 503, can augment the selected frames of the audio data based on the selected augmentation technique(s) to generate an augmented audio data set 402. For example, when a temporal modification augmentation technique has been selected for frames of the audio data 401, the audio augmentation system 420 can alter the timing of the frames of the audio data 401, such as stretching or squeezing the frames of the audio data 401. When a distance adjustment augmentation technique has been selected for frames of the audio data 401, the audio augmentation system 420 can alter an amplitude of the frames of the audio data 401 to simulate a different distance of the object in the environment. When an environmental augmentation technique has been selected for frames of the audio data 401, the audio augmentation system 420 can insert noise into the frames of the audio data 401 or dampen noise in the frames of the audio data 401 to simulate different environments.

In some embodiments, the audio augmentation system 420 can augment a frame of the audio data 401 with multiple different augmentation techniques to generate at least one augmented audio frame for the augmented audio data set 402. For example, the audio augmentation system 420 can utilize both the distance adjustment augmentation technique and the environmental augmentation technique on a frame of the audio data 401 to generate an augmented frame of the audio data 401 simulating both a different distance and a different environment for the object associated with the sounds in the frame of the audio data 401.

The audio augmentation system 420 can include a temporal modification unit 422 to implement a temporal modification augmentation technique, which can alter the timing of the frame of the audio data 401 to simulate the sounds occurring in the environment at a different pace or rate. For example, when the frame of audio data 401 corresponds to a siren, the temporal modification unit 422 can alter the timing of the frame of the audio data 401 by slowing down or speeding up the siren to simulate different versions of the siren that may be present in the environment. In another example, when the frame of audio data 401 corresponds to an engine accelerating, the temporal modification unit 422 can alter the timing of the frame of the audio data 401 by slowing down or speeding up the sounds corresponding to the rate of acceleration.

In some embodiments, the temporal modification unit 422 can alter the timing of the frame of the audio data 401 by resampling the frames of the audio data 401 at a different sampling rate. In another embodiment, the temporal modification unit 422 can alter the timing of the frame of the audio data 401 by overlapping portions of the frames of the audio data 401. For example, the temporal modification unit 422 can divide a frame of the audio data 401 into multiple audio segments, arrange the audio segments side-by-side, and then adjust an overlap between the audio segments arranged side-by-side. By varying the overlap of the audio segments in the audio frame, the temporal modification unit 422 can stretch or squeeze the timing of the frame of the audio data 401.

The audio augmentation system 420 can include a distance adjustment unit 424 to implement a distance adjustment augmentation technique, which can augment the audio data 401 to simulate objects emitting sounds at different distances. In some embodiments, the distance adjustment unit 424 can adjust an amplitude of the audio data 401 to simulate objects emitting sounds at different distances. For example, when the audio data 401 corresponds to analog data, the distance adjustment unit 424 can vary a resistance associated with the audio data 401 to adjust the amplitude of the analog data. When the audio data 401 corresponds to digital data, the distance adjustment unit 424 can scale the digital data values to adjust the amplitude of the analog data.

The audio augmentation system 420 can include an environment variance unit 426 to implement an environmental augmentation technique, which can dampen noise in the audio data 401 to simulate objects emitting sounds within different environments, such as a tunnel, under and overpass, or the like. For example, the environment variance unit 426 can dampen noise within the audio data 401 by convolving the audio data 401 with a distribution function, such as a Gaussian distribution function, a normal distribution function, a square distribution function, or the like.

The environment variance unit 426 also can implement an environmental augmentation technique by incorporating noise into the audio data 401, which can simulate objects emitting sounds in different traffic situations. The environment variance unit 426 can select a sample of noise corresponding to a different environment and superimpose the selected noise sample with the audio data 401. In some embodiments, the environment variance unit 426 can select the noise sample from a repository storing multiple noise samples corresponding to various traffic environments and situations. The addition of noise to the audio data 401 can allow the environment variance unit 426 to simulate objects emitting sounds in different traffic situations.

The audio data expansion system 400 can include a labeling unit 430 that, in a block 504, can label the augmented audio data set 402. In some embodiments, the labeling unit 430 can parse the audio data 401 to identify a label included in the audio data 410. The labeling unit 430 can correlate the audio data 401 to an augmented version of the audio data 401 generated by the audio augmentation system 420 and attached the identified label to the augmented version of the audio data 401. The labeling unit 430 can perform the labeling for each augmented frame of audio data for inclusion in the augmented audio data set 402.

In a block 505, the audio processing system can train a machine learning classifier with the augmented audio data set 402. The machine learning classifier can receive the labeled augmented audio data set 402 from the audio processing system and utilize the augmented audio data set 402 to train nodes of a machine-learning network to identify different types of sound and indicate a type of object that emitted the identified sound based on the labels in the augmented audio data set 402. In some embodiments, the audio processing system can divide the augmented audio data set 402 into multiple sets, for example, for training the machine-learning classifier, testing the machine-learning classifier, and/or validating the machine-learning classifier.

The machine-learning classifier, once trained, can receive sound measurements captured in the environment, for example, from one or more microphones, an infrasound capture device, an ultrasound capture device, or the like mounted in a vehicle or in a stationary installation, and, in a block 506, can classify the sound measurements as corresponding to a type of an object based on its training. The machine-learning classifier can output an object classification indicating the object type, which can be assigned to the captured sound measurements, for example, in an environmental model for a sensor fusion system. In some embodiments, the object classification can be utilized by a driving functionality system to implement automated driving functionality or automated safety and assisted driving functionality for the vehicle.

### Illustrative Operating Environment

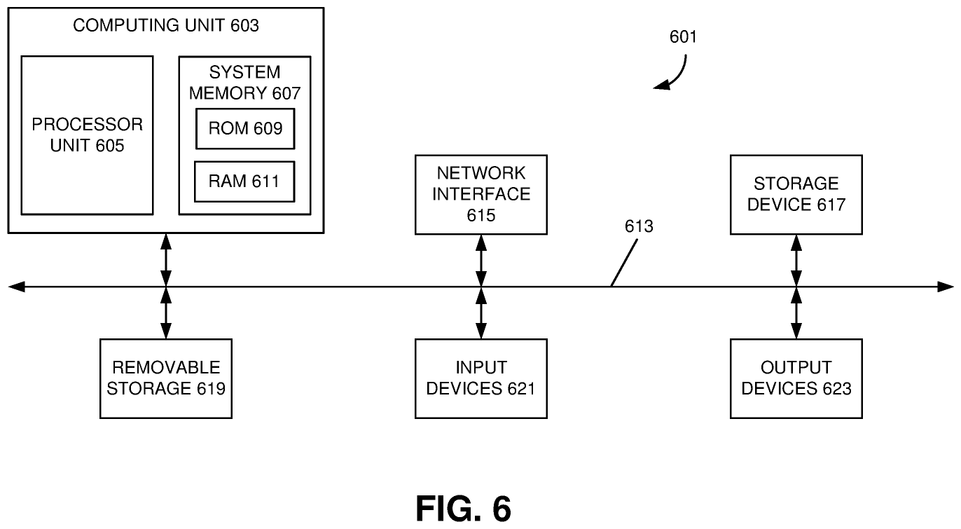

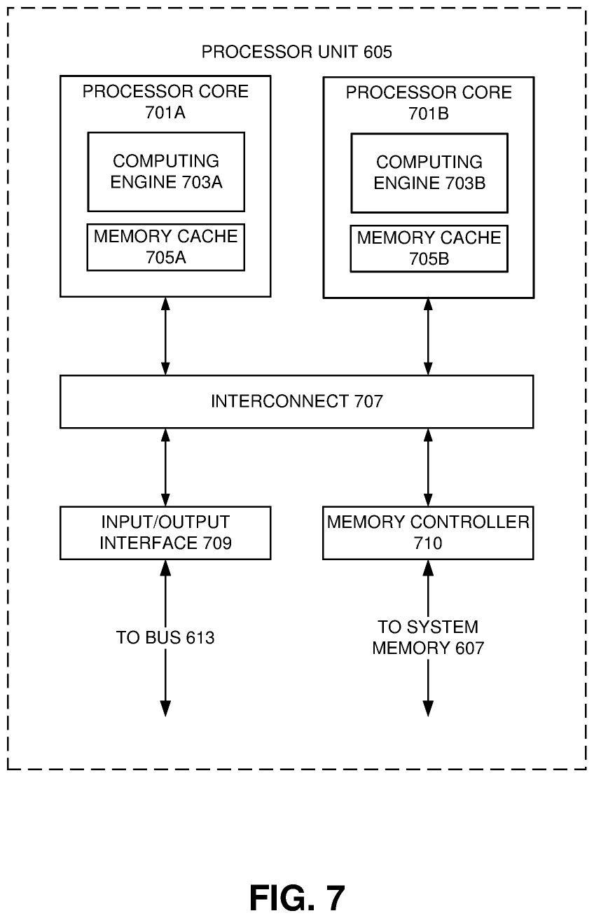

FIGS. 6 and 7 illustrate an example of a computer system of the type that may be used to implement various embodiments. Referring to FIG. 6, various examples may be implemented through the execution of software instructions by a computing device 601, such as a programmable computer. Accordingly, FIG. 6 shows an illustrative example of a computing device 601. As seen in FIG. 6, the computing device 601 includes a computing unit 603 with a processor unit 605 and a system memory 607. The processor unit 605 may be any type of programmable electronic device for executing software instructions, but will conventionally be a microprocessor. The system memory 607 may include both a read-only memory (ROM) 609 and a random access memory (RAM) 611. As will be appreciated by those of ordinary skill in the art, both the read-only memory (ROM) 609 and the random access memory (RAM) 611 may store software instructions for execution by the processor unit 605.

The processor unit 605 and the system memory 607 are connected, either directly or indirectly, through a bus 613 or alternate communication structure, to one or more peripheral devices 617-623. For example, the processor unit 605 or the system memory 607 may be directly or indirectly connected to a storage device 617 and a removable storage 619, such as a hard disk drive, which can be magnetic and/or removable, solid state memory device, a removable optical disk drive, and/or a flash memory card. The processor unit 605 and the system memory 607 may also be directly or indirectly connected to one or more input devices 621 and one or more output devices 623. The input devices 621 may include, for example, a keyboard, a pointing device (such as a mouse, touchpad, stylus, trackball, or joystick), a scanner, a camera, and a microphone. The output devices 623 may include, for example, a monitor display, a printer and speakers. With various examples of the computing device 601, one or more of the peripheral devices 617-623 may be internally housed with the computing unit 603. Alternately, one or more of the peripheral devices 617-623 may be external to the housing for the computing unit 603 and connected to the bus 613 through, for example, a Universal Serial Bus (USB) connection.

With some implementations, the computing unit 603 may be directly or indirectly connected to a network interface 615 for communicating with other devices making up a network. The network interface 615 can translate data and control signals from the computing unit 603 into network messages according to one or more communication protocols, such as the transmission control protocol (TCP) and the Internet protocol (IP). Also, the network interface 615 may employ any suitable connection agent (or combination of agents) for connecting to a network, including, for example, a wireless transceiver, a modem, or an Ethernet connection. Such network interfaces and protocols are well known in the art, and thus will not be discussed here in more detail.

It should be appreciated that the computing device 601 is illustrated as an example only, and it not intended to be limiting. Various embodiments may be implemented using one or more computing devices that include the components of the computing device 601 illustrated in FIG. 6, which include only a subset of the components illustrated in FIG. 6, or which include an alternate combination of components, including components that are not shown in FIG. 6. For example, various embodiments may be implemented using a multi-processor computer, a plurality of single and/or multiprocessor computers arranged into a network, or some combination of both.

With some implementations, the processor unit 605 can have more than one processor core. Accordingly, FIG. 7 illustrates an example of a multi-core processor unit 605 that may be employed with various embodiments. As seen in this figure, the processor unit 605 includes a plurality of processor cores 701A and 701B. Each processor core 701A and 701B includes a computing engine 703A and 703B, respectively, and a memory cache 705A and 705B, respectively. As known to those of ordinary skill in the art, a computing engine 703A and 703B can include logic devices for performing various computing functions, such as fetching software instructions and then performing the actions specified in the fetched instructions. These actions may include, for example, adding, subtracting, multiplying, and comparing numbers, performing logical operations such as AND, OR, NOR and XOR, and retrieving data. Each computing engine 703A and 703B may then use its corresponding memory cache 705A and 705B, respectively, to quickly store and retrieve data and/or instructions for execution.

Each processor core 701A and 701B is connected to an interconnect 707. The particular construction of the interconnect 707 may vary depending upon the architecture of the processor unit 605. With some processor cores 701A and 701B, such as the Cell microprocessor created by Sony Corporation, Toshiba Corporation and IBM Corporation, the interconnect 707 may be implemented as an interconnect bus. With other processor units 701A and 701B, however, such as the Opteron™ and Athlon™ dual-core processors available from Advanced Micro Devices of Sunnyvale, Calif., the interconnect 707 may be implemented as a system request interface device. In any case, the processor cores 701A and 701B communicate through the interconnect 707 with an input/output interface 709 and a memory controller 710. The input/output interface 709 provides a communication interface between the processor unit 605 and the bus 613. Similarly, the memory controller 710 controls the exchange of information between the processor unit 605 and the system memory 607. With some implementations, the processor unit 605 may include additional components, such as a high-level cache memory accessible shared by the processor cores 701A and 701B. It also should be appreciated that the description of the computer network illustrated in FIG. 6 and FIG. 7 is provided as an example only, and it not intended to suggest any limitation as to the scope of use or functionality of alternate embodiments.

The system and apparatus described above may use dedicated processor systems, micro controllers, programmable logic devices, microprocessors, or any combination thereof, to perform some or all of the operations described herein. Some of the operations described above may be implemented in software and other operations may be implemented in hardware. Any of the operations, processes, and/or methods described herein may be performed by an apparatus, a device, and/or a system substantially similar to those as described herein and with reference to the illustrated figures.

The processing device may execute instructions or “code” stored in a computer-readable memory device. The memory device may store data as well. The processing device may include, but may not be limited to, an analog processor, a digital processor, a microprocessor, a multi-core processor, a processor array, a network processor, or the like. The processing device may be part of an integrated control system or system manager, or may be provided as a portable electronic device configured to interface with a networked system either locally or remotely via wireless transmission.

The processor memory may be integrated together with the processing device, for example RAM or FLASH memory disposed within an integrated circuit microprocessor or the like. In other examples, the memory device may comprise an independent device, such as an external disk drive, a storage array, a portable FLASH key fob, or the like. The memory and processing device may be operatively coupled together, or in communication with each other, for example by an I/O port, a network connection, or the like, and the processing device may read a file stored on the memory. Associated memory devices may be “read only” by design (ROM) by virtue of permission settings, or not. Other examples of memory devices may include, but may not be limited to, WORM, EPROM, EEPROM, FLASH, NVRAM, OTP, or the like, which may be implemented in solid state semiconductor devices. Other memory devices may comprise moving parts, such as a known rotating disk drive. All such memory devices may be “machine-readable” and may be readable by a processing device.

Operating instructions or commands may be implemented or embodied in tangible forms of stored computer software (also known as “computer program” or “code”). Programs, or code, may be stored in a digital memory device and may be read by the processing device. “Computer-readable storage medium” (or alternatively, “machine-readable storage medium”) may include all of the foregoing types of computer-readable memory devices, as well as new technologies of the future, as long as the memory devices may be capable of storing digital information in the nature of a computer program or other data, at least temporarily, and as long at the stored information may be “read” by an appropriate processing device. The term “computer-readable” may not be limited to the historical usage of “computer” to imply a complete mainframe, mini-computer, desktop or even laptop computer. Rather, “computer-readable” may comprise storage medium that may be readable by a processor, a processing device, or any computing system. Such media may be any available media that may be locally and/or remotely accessible by a computer or a processor, and may include volatile and non-volatile media, and removable and non-removable media, or any combination thereof.

A program stored in a computer-readable storage medium may comprise a computer program product. For example, a storage medium may be used as a convenient means to store or transport a computer program. For the sake of convenience, the operations may be described as various interconnected or coupled functional blocks or diagrams. However, there may be cases where these functional blocks or diagrams may be equivalently aggregated into a single logic device, program or operation with unclear boundaries.

### CONCLUSION

While the application describes specific examples of carrying out embodiments, those skilled in the art will appreciate that there are numerous variations and permutations of the above described systems and techniques that fall within the spirit and scope of the invention as set forth in the appended claims. For example, while specific terminology has been employed above to refer to systems and processes, it should be appreciated that various examples of the invention may be implemented using any desired combination of systems and processes.

One of skill in the art will also recognize that the concepts taught herein can be tailored to a particular application in many other ways. In particular, those skilled in the art will recognize that the illustrated examples are but one of many alternative implementations that will become apparent upon reading this disclosure.

Although the specification may refer to “an”, “one”, “another”, or “some” example(s) in several locations, this does not necessarily mean that each such reference is to the same example(s), or that the feature only applies to a single example.

1. A method comprising:
receiving, by a computing system, audio data corresponding to sounds emitted by objects capable of being identified in an environment;
altering, by the computing system, the audio data to generate an augmented audio data set having multiple different versions of the audio data; and
training a machine-learning classification system with the augmented audio data set, wherein the training configures the machine-learning classification system to classify sound measurements captured from the environment with one or more audio devices.

2. The method of claim 1, wherein altering the audio data to generate augmented audio data set further comprises modifying a timing of the audio data to simulate objects emitting sounds at a different temporal pace.

3. The method of claim 1, wherein altering the audio data to generate augmented audio data set further comprises adjusting an amplitude of the audio data to simulate objects emitting sounds at different distances.

4. The method of claim 1, wherein altering the audio data to generate augmented audio data set further comprises incorporating noise corresponding to different traffic environments into the audio data to simulate objects emitting sounds in a traffic situation.

5. The method of claim 1, wherein altering the audio data to generate augmented audio data set further comprises dampening noise in the audio data to simulate objects emitting sounds within different environments.

6. The method of claim 1, wherein the audio data includes labels identifying types of the objects emitting the sounds associated with the audio data, and further comprising labeling, by the computing system, the augmented audio data set with the labels of the audio data altered to generate the augmented audio data set.

7. The method of claim 1, further comprising classifying, by the machine-learning classification system trained with the augmented audio data set, audio measurements captured with the one or more audio devices as corresponding to a type of object in the environment around a vehicle, wherein a control system for the vehicle is configured to control operation of the vehicle based, at least in part, on the type of object corresponding to the classified audio measurements.

8. An apparatus comprising at least one memory device storing instructions configured to cause one or more processing devices to perform operations comprising:
receiving audio data corresponding to sounds emitted by objects capable of being identified in an environment; and
altering the audio data to generate an augmented audio data set having multiple different versions of the audio data, wherein a machine-learning classification system trained with the augmented audio data set is configured to classify sound measurements captured from the environment with one or more audio devices.

9. The apparatus of claim 8, wherein altering the audio data to generate augmented audio data set further comprises modifying a timing of the audio data to simulate objects emitting sounds at a different temporal pace.

10. The apparatus of claim 8, wherein altering the audio data to generate augmented audio data set further comprises adjusting an amplitude of the audio data to simulate objects emitting sounds at different distances.

11. The apparatus of claim 8, wherein altering the audio data to generate augmented audio data set further comprises incorporating noise corresponding to different traffic environments into the audio data to simulate objects emitting sounds in a traffic situation.

12. The apparatus of claim 8, wherein altering the audio data to generate augmented audio data set further comprises dampening noise in the audio data to simulate objects emitting sounds within different environments.

13. The apparatus of claim 8, wherein the audio data includes labels identifying types of the objects emitting the sounds associated with the audio data, and wherein the instructions are further configured to cause the one or more processing devices to perform operations comprising labeling the augmented audio data set with the labels of the audio data altered to generate the augmented audio data set.

14. The apparatus of claim 8, wherein the machine-learning classification system trained with the augmented audio data set is configured to classify audio measurements captured with the one or more audio devices as corresponding to a type of object in the environment around a vehicle, wherein a control system for the vehicle is configured to control operation of the vehicle based, at least in part, on the type of object corresponding to the classified audio measurements.

15. A system comprising:
a memory device configured to store machine-readable instructions; and
a computing system including one or more processing devices, in response to executing the machine-readable instructions, configured to:
receive audio data corresponding to sounds emitted by objects capable of being identified in an environment; and
alter the audio data to generate an augmented audio data set having multiple different versions of the audio data, wherein a machine-learning classification system trained with the augmented audio data set is configured to classify sound measurements captured from the environment with one or more audio devices.

16. The system of claim 15, wherein the one or more processing devices, in response to executing the machine-readable instructions, are configured to alter the audio data by modifying a timing of the audio data to simulate objects emitting sounds at a different temporal pace.

17. The system of claim 15, wherein the one or more processing devices, in response to executing the machine-readable instructions, are configured to alter the audio data by adjusting an amplitude of the audio data to simulate objects emitting sounds at different distances.

18. The system of claim 15, wherein the one or more processing devices, in response to executing the machine-readable instructions, are configured to alter the audio data by incorporating noise corresponding to different traffic environments into the audio data to simulate objects emitting sounds in a traffic situation or by dampening noise in the audio data to simulate objects emitting sounds within different environments.

19. The system of claim 15, wherein the audio data includes labels identifying types of the objects emitting the sounds associated with the audio data, and wherein the one or more processing devices, in response to executing the machine-readable instructions, are configured to label the augmented audio data set with the labels of the audio data altered to generate the augmented audio data set.

20. The system of claim 15, wherein the machine-learning classification system trained with the augmented audio data set is configured to classify audio measurements captured with the one or more audio devices as corresponding to a type of object in the environment around a vehicle, wherein a control system for the vehicle is configured to control operation of the vehicle based, at least in part, on the type of object corresponding to the classified audio measurements.
